(19) United States
(12) Patent Application Publication
(10) Pub. No.: US 2006/0168227 A1
(43) Pub. Date: Jul. 27, 2006

(54) System, method, device, module and computer code product for progressively downloading a content file

(75) Inventors: Oren Levine, Waltham, MA (US); Sami Pippuri, Espoo (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/997,831

(22) Filed: Nov. 24, 2004

(51) Int. Cl. G06F 15/16; G06F 15/173

(52) U.S. Cl. 709/226; 709/217

(57) ABSTRACT

A system and method for progressively downloading a content file. An electronic device including a browser application, and a server including a metafile and an associated content file. When a user desires to progressively download the content file to the electronic device, the electronic device reads the metafile to determine whether the content file is capable of being subject to progressive downloading. If the content file is capable of being subject to progressive downloading, the content file is progressively downloaded to the electronic device.

### FIELD OF THE INVENTION

The present invention relates generally to the progressive downloading of media content. More particularly, the present invention relates to the progressive downloading of media content using an Internet browser.

### BACKGROUND INFORMATION

In recent years, the purchasing and downloading of media files through the Internet has exploded in popularity. Several different services have been created through which customers can quickly browse, purchase and download media files such as audio files, video files, and more. These download services typically operate through a multimedia player application, such as the popular iTunes application, or operate in conjunction with a user's Internet browser.

In situations where a user is browsing inside an online music/video download service site using a standard Internet browser, the download service is attempting to provide the best possible user experience by requiring only a minimal amount of waiting time for the user when the user is making purchase decisions. Generally, users of such services want to be able to listen and/or view purchased media tracks as soon as possible after the decision has been made to purchase the respective track. In response to this need, devices often include a “progressive download feature,” which permits a user to view and/or listen to a downloaded portion of a media file while the remainder of the file is still in the process of being downloaded.

Due to the nature of media formats, however, particularly when digital rights management (DRM) protection is applied, various browser applications may not be able to determine if content to be downloaded is capable of a progressive download. For example, in open mobile alliance (OMA) DRM systems, content is encrypted and placed in a “wrapper” format. In this format, it is not immediately apparent to the receiving application and device whether the content is amenable to a progressive download, since the receiving application does not know the true content type or content characteristics prior to starting to study the file's contents. In addition, systems such as OMA Download 1.0 explicitly forbid the progressive downloading of content.

The issue of determining whether progressive downloading is possible has been addressed in personal computers through the use of Advanced Stream Redirectors (in the form of .asx files) and RealMedia metafiles (in the form of .ram files), which serve as streaming links to media content. However, no such system currently exists in the mobile environment, and this situation is only exacerbated when DRM and OMA systems are involved. In the case of .ram files, these metafiles only contain rtsp://url streaming protocol and therefore cannot be used for progressive downloading. For .asx files, the browser detects what type of content is coming from the server and opens the handler for that particular content. Unfortunately, however, this system does not work with protected content due to content type being DRM protected.

### SUMMARY OF THE INVENTION

The present invention provides for a text-based metafile that is defined to aid a server and device to determine whether a particular piece of content is amenable to progressive downloading. The server hosts the metafile, which contains a link to the actual content file. The metafile includes information concerning whether the actual content file is capable of progressive downloading, as well as which application is capable of handling the progressive download.

The present invention provides for a number of advantages over conventional systems. The present invention involves a minimal amount of effort for successful implementation, while addressing the issue of how to determine whether a file is capable of progressive downloading. Additionally, the browser applications on the system are capable of immediately dispatching the content based upon the multipurpose internet mail extension (MIME) type of the file at issue.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system according to an embodiment of the present invention;

FIG. 2 is a perspective view of a mobile telephone that can be used in the implementation of the present invention;

FIG. 3 is a schematic representation of the telephone circuitry of the mobile telephone of FIG. 2; and

FIG. 4 is a flow chart showing a process for implementation of one embodiment of the present invention.

### DETAILED DESCRIPTION OF THE PREFERRED EMBODIMENTS

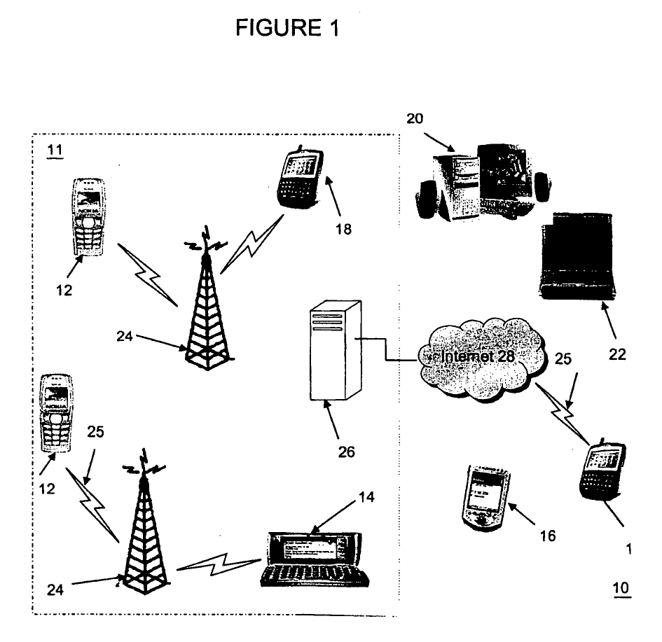

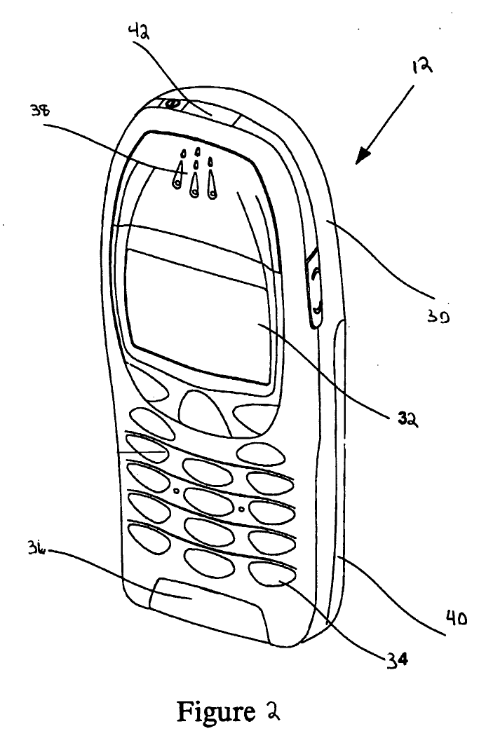

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

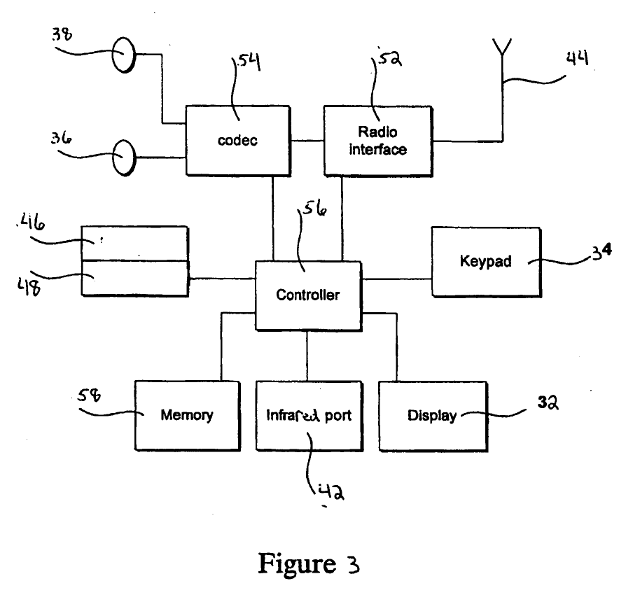

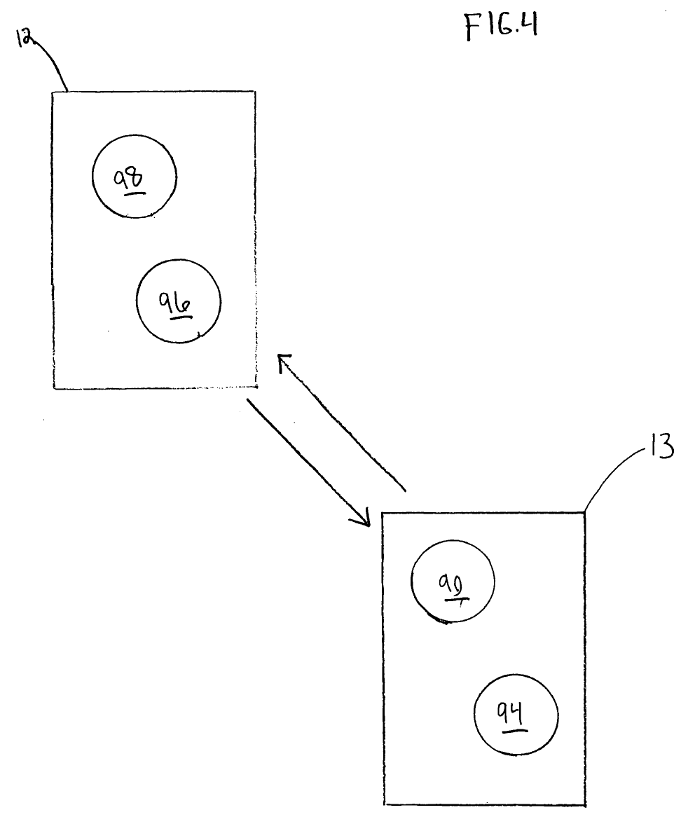

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention involves the use of a browser application, a new media type for a simple text-based metafile, a content server and a content handler application which is dispatched with the downloaded content in the device. It should be noted, however, that the present invention is not intended to be limited to interacting with a content server, but can instead can involve the interacting between virtually any two electronic devices.

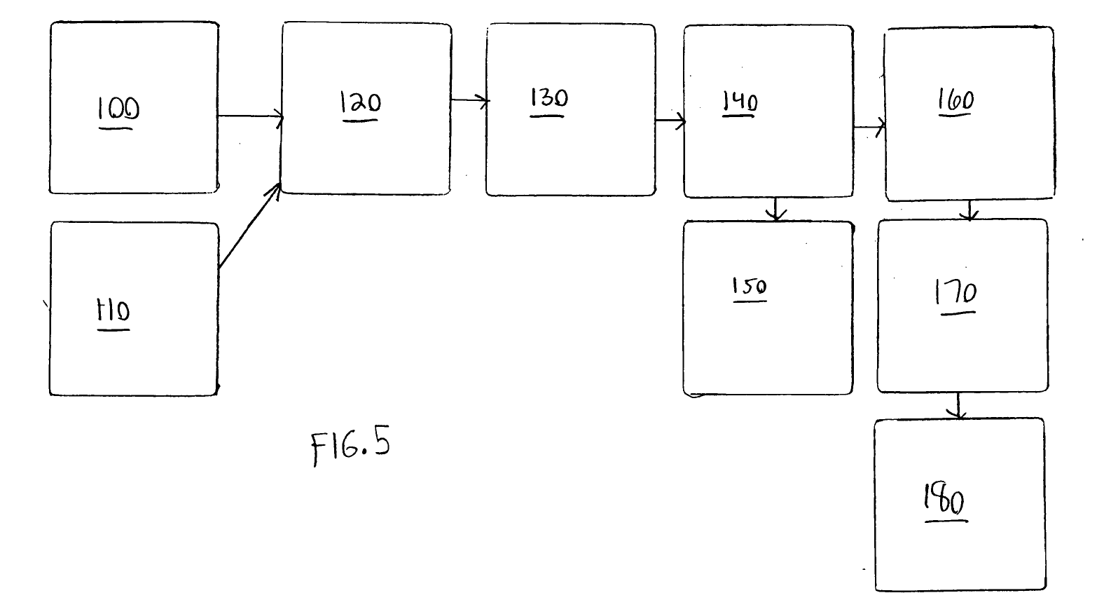

As shown generically in FIG. 4 and according to the principles of the present invention, a metafile 90 is defined to aid a generic server 13 and the mobile telephone 12 or other electronic device in determining whether a piece of content 94 is amenable to progressive downloading. The generic server 13 hosts a generated text file which serves as the metafile 90. The metafile 90 contains a link to the actual content file 94. The metafile 90 is formatted, in one embodiment of the invention, to be simple in form and of a small file size.

The metafile 90 of the present invention includes its own registered MIME type, which is used by a browser 96 on the mobile telephone 12 to perform a number of tasks. First, the browser 96 uses the metafile 90 to determine whether the linked content 94 is organized in a way such that it is capable of progressive downloading. Second, the browser 96 uses the metafile 90 to determine which associated application 98 is capable of handling the progressive download (by using a document handler registry). Third, the browser 96 uses the metafile 90 to launch the correct application 98 which has registered itself as the handler for the content 94 being subject to progressive download.

In the case of OMA Download (DLOTA) Version 1.0, a download agent is responsible for delivering the text file of the present invention. According to DLOTA 1.0, content cannot be rendered before being completely downloaded and after an InstallNotify instruction has been sent. In this case, the object is the small metafile 90, the InstallNotify instruction is sent as soon as the metafile 90 is downloaded, and the progressive download (“PD”) can be handled by the correct application outside of the DLOTA session.

One implementation of the present invention is generally as follows. The format for the text file or metafile 90 can be very simple. For example, the format can be in the form of:

Type=audio/aac

Location=http://www.provider.com/content/clip.odf

In this example, the metafile 90 includes a content type string for the referenced content 94, as well as a link to the actual content 94. It should be noted that the actual content is wrapped inside a DRM content format, and the HTTP server will return a content type string of applicaton/vnd.oma.drm.dcf, instead of audio/aac, which is the content inside the wrapper format. To determine which type of a player should handle the content 94, the content type string in the metafile 90 can be used. The content type strong is used particularly to address the situation where there are several applications registered for handling the PD metafile type.

The metafile of the present invention is assigned a particular MIME type. This type can take virtually any form, e.g. application/vnd.nok.pd-desc, etc.

FIG. 5 shows a generic process for the implementation of one embodiment of the present invention. At steps 100 and 110, a server and a device are presented, respectively. At step 120, the server is provided the content 94 for available download by the device and an associated metafile. At step 130, the device contacts the server to download the content 94. In one embodiment of the invention, the device is capable of indicating to the server that it supports progressive downloading by signaling the metafile MIME type in the browser's “Accept” header. At step 140, device accesses the metafile 90 and reads the metafile to determine whether the linked content 94 is progressively downloadable. At step 150, if the linked content 94 is not capable of being progressively downloaded, the download process begins in a normal, nonprogressive manner. At step 160, if a progressive download is possible, the browser 96 uses the metafile 90 to determine which associated application 98 is capable of handling the progressive download. At step 170, the browser uses the metafile 90 to launch the correct application 98, which has registered itself as the handler for the progressive download content 94. At step 180, the progressive downloading of the content 94 takes place.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for progressively downloading a content file, comprising:
providing a first electronic device;
providing a second electronic device including the content file and an associated metafile;
having the first electronic device communicate with the second electronic device to download the content file;
having the first electronic device read the metafile to determine whether the content file is capable of progressive downloading;
if a progressive download is possible, having the first electronic device read the metafile to determine the identity of an associated application to handle the progressive download of the content file;
having the first electronic device launch the associated application; and
having the first electronic device progressively download the content file.

2. The method of claim 1, wherein the metafile comprises:
a link to the location of the content file; and
a content type string for the content file.

3. The method of claim 1, wherein the metafile includes information regarding the associated application.

4. The method of claim 1, wherein the content file is selected from the group consisting of an audio file and a video file.

5. The method of claim 1, wherein the content file includes digital rights management protection.

6. The method of claim 1, further comprising, before having the first electronic device progressively download the content file, having the first electronic device transmit an InstallNotify instruction to the second electronic device.

7. A computer program product for providing progressive downloading of a content file, comprising:
computer code for providing the location of a content file and an associated metafile, wherein the associated metafile comprises;
a link to the location of the content file, and
a content type string for the content file; and
computer code for providing to an electronic device the associated metafile.

8. The computer program product of claim 7, wherein the content file includes digital rights management protection.

9. The computer program product of claim 7, wherein the metafile includes information regarding an associated application.

10. A computer program product for progressively downloading a content file, comprising:
computer code for receiving a metafile associated with the content file,
computer code for reading the metafile to determine whether the content file is capable of progressive downloading;
computer code for reading the metafile to determine the identity of an associated application to handle the progressive downloading of the content file;
computer code for launching the associated application; and
computer code for progressively download the content file.

11. The computer program product of claim 10, wherein the content file includes digital rights management protection.

12. The computer program product of claim 10, wherein the content file is selected from the group consisting of an audio file and a video file.

13. The computer program product of claim 10, further comprising computer code for, before progressively downloading the content file, transmitting an InstallNotify instruction.

14. A system for progressively downloading a content file, comprising:
a first electronic device including a browser application; and
a second electronic device including a metafile and an associated content file,
wherein when a user desires to progressively download the content file to the first electronic device, the first electronic device reads the metafile to determine whether the content file is capable of being subject to progressive downloading, and wherein if the content file is capable of being subject to progressive downloading, the content file is progressively downloaded to the electronic device.

15. The system of claim 14, wherein the metafile includes information regarding the associated application.

16. The system of claim 14, wherein the content file includes digital rights management protection.

17. The system of claim 14, wherein the metafile comprises:
a link to the location of the content file; and
a content type string for the content file

18. An electronic device, comprising:
a processor;
a memory unit operatively connected to the processor; and
a data communication link for communicating with a different electronic device,
wherein the memory unit includes a computer program product comprising:
computer code for providing the location of a content file and an associated metafile, wherein the associated metafile comprises;
a link to the location of the content file; and
a content type string for the content file, and
computer code for providing to the different electronic device the associated metafile.

19. The electronic device of claim 18, wherein the content file includes digital rights management protection.

20. The electronic device of claim 18, wherein the metafile includes information regarding an associated application.

21. An electronic device, comprising:
a processor;
a memory unit operatively connected to the processor; and
a data communication link for communicating with a different electronic device,
wherein the memory unit includes a computer program product comprising:
computer code for receiving a metafile associated with the content file,
computer code for reading the metafile to determine whether the content file is capable of progressive downloading;
computer code for reading the metafile to determine the identity of an associated application to handle the progressive download of the content file;
computer code for launching the associated application; and
computer code for progressively downloading the content file.

22. The electronic device of claim 21, wherein the content file includes digital rights management protection.

23. The electronic device of claim 21, wherein the metafile comprises:
a link to the location of the content file; and
a content type string for the content file

24. A module for providing progressive downloading of a content, comprising:
a processor; and
a memory unit operatively connected to the processor, the memory unit including a computer program product comprising:
computer code for providing the location of a content file and an associated metafile, wherein the associated metafile comprises;
a link to the location of the content file; and
a content type string for the content file, and
computer code for providing the associated metafile.

25. The module of claim 24, wherein the content file includes digital rights management protection.

26. The module of claim 24, wherein the metafile includes information regarding an associated application.

27. A module for progressively downloading of a content file, comprising:
a processor; and
a memory unit operatively connected to the processor, the memory unit including a computer program product comprising:
computer code for receiving a metafile associated with the content file,
computer code for reading the metafile to determine whether the content file is capable of progressive downloading;
computer code for reading the metafile to determine the identity of an associated application to handle the progressive download of the content file;
computer code for launching the associated application; and
computer code for progressively downloading the content file.

28. The module of claim 27, wherein the content file includes digital rights management protection.

29. The module of claim 27, wherein the content file is selected from the group consisting of an audio file and a video file.

30. The module of claim 27, further comprising computer code for, before progressively download the content file, transmitting an InstallNotify instruction.
